(19) United States
(12) Patent Application Publication
(10) Pub. No.: US 2008/0212023 A1
(43) Pub. Date: Sep. 4, 2008

(54) Pixellized Optical Component with Apodized Walls, Method for Making Same and Use thereof in Making a Transparent Optical Element

(75) Inventors: Christian Bovet, Charenton Le Pont (FR); Jean-Paul Cano, Charenton Le Pont (FR); Gilles Mathieu, Charenton Le Pont (FR)

Correspondence Address: OCCHIUTI ROHLICEK & TSAO, LLP, 10 FAWCETT STREET, CAMBRIDGE, MA, 02138, US

(73) Assignee: Essilor International (Compagnie Generale D'Optique), Charenton Le Pont (FR)

(21) Appl. No.: 11/996,111

(22) PCT Filed: Jul. 13, 2006
(86) PCT No.: PCT/FR2006/001724

§ 371 Date: Jan. 18, 2008

(30) Foreign Application Priority Data
Jul. 20, 2005 (FR) 0507717

(51) Int. Cl. G02C 7/02

(52) U.S. Cl. 351/174; 351/177

(57) ABSTRACT

The invention concerns a transparent optical component (10) comprising at least one transparent set of cells (15) juxtaposed parallel to a surface of the component, each cell being separated by walls (18) with apodized profile parallel to the surface of the component, and each cell being hermetically sealed and containing at least one substance with optical property. The cells (15) can in particular have a Gaussian profile of walls. The invention also concerns a method for making such an optical component as well as its use for making an optical element. The optical element can in particular be a spectacle lens.

The present invention relates to the production of transparent elements incorporating optical functions. It applies in particular to the production of ophthalmic lenses having various optical properties.

Ametropia-correcting lenses are conventionally manufactured by the forming of a transparent material having a refractive index higher than that of air. The shape of the lenses is chosen so that the refraction at the material/air interfaces causes suitable focusing onto the retina of the wearer. The lens is generally cut so as to fit into a spectacle frame, with appropriate positioning relative to the pupil of the corrected eye.

Among the various types of lenses, or of others not necessarily limited to ophthalmic optics, it would be desirable to be able to provide a structure for introducing one or more optical functions in a flexible and modular manner, while still maintaining the possibility of cutting the optical element obtained for the purpose of incorporating it into an imposed frame, or one chosen elsewhere, or into any other means of retaining said optical element.

One object of the present invention is to meet this requirement. Another object is for the optical element to be produced under proper industrial conditions.

The invention thus provides a method of producing a transparent optical element, which includes the step of producing a transparent optical component having at least one set of cells juxtaposed parallel to one surface of the component, each cell being hermetically sealed and containing a substance having an optical property, the cells being separated by walls having an apodized profile.

The invention also provides a method of producing a transparent optical element, which additionally includes a step of cutting said optical component along a defined contour on said surface, corresponding to a defined shape for the optical element.

The cells may be filled with various substances chosen for their optical properties, for example properties associated with their refractive index, with their light absorption or polarization capability, with their response to electrical or light stimuli, etc.

The structure therefore lends itself to many applications, particularly those making use of variable optical functions. This implies discretization of the surface of the optical element by pixels, offering great flexibility in the design but also in the implementation of the element. This discretization by pixels is thus manifested on the surface of the optical component by the production of an array of cells, the cells being separated by walls with an apodized profile. Such a wall profile is particularly advantageous for the production of a transparent optical component with no loss of contrast when an image is observed through said component.

It is possible to produce pixelated structures via discretization, which consist of a succession of adjacent cells in the plane. These cells are separated by walls and are the cause of a lack of transparency of the optical component. Within the context of the invention, an optical [symbol] observed through said optical component is perceived without significant loss of contrast, that is to say when the formation of an image through said optical component is obtained without impairing the quality of the image. This definition of the term “transparent” is applicable, within the context of the invention, to all of the objects termed as such in the description.

The walls separating the cells of the optical component interact with the light, diffracting it. Diffraction is defined as the light scattering phenomenon observed when a lightwave is materially bounded (J-P. Perez, “Optique: fondements et Applications [Optics: Basics and Applications], 7th edition, published by Dunod, October 2004, page 262). Thus, an optical component comprising such walls transmits a degraded image owing to this light scattering induced by said walls. This microscopic diffraction is manifested macroscopically by the scattering, and in the case of a point source, this microscopic diffraction is characterized by a scattering spot, which results in a loss of contrast of the image observed through said structure. This loss of contrast can be likened, within the context of the invention, to a loss of transparency as defined above. This is unacceptable for producing an optical element comprising a pixelated optical component as understood within the context of the invention. This is all the more so if said optical element is an ophthalmic lens, which must on the one hand be transparent and on the other hand must have no cosmetic defect that may impair the vision of the person wearing such an optical element.

One object of the present invention is to reduce this scattering spot so as to reduce the loss of contrast. The production of an array of cells having walls of apodized profile makes it possible to reduce the spread of the scattering spot and therefore to increase the

[symbol]

The energy of the light impinging onto a wall is concentrated in a solid angle and its perception becomes a scattering spot having an angle θ, a length D and a light intensity I. To minimize the scattering, it is necessary to be able to have an influence on at least one of these three parameters (θ, D, I). The intensity is mainly due to the number of walls present within the component and to their distribution on the surface of said optical component. The length D is more linked to the geometry of the walls, and a means of minimizing this term consists in apodizing the walls separating the cells of the constituent array of the pixelated optical component. By apodizing the walls, the length of the scattering spot is locally reduced by suppressing the side lobes.

Within the context of the invention, the term “apodizing” is understood to mean smoothing the shape of the walls. This smoothing amounts to producing a filter, which suppresses the high spatial frequencies of a Fourier spectrum and thus prevents wide-angle diffraction. The elimination of wide-angle diffraction results in enhanced contrast and therefore an improvement in the quality of the image that can be perceived through such a pixelated system. This apodization thus corresponds, according to the invention, to geometric smoothing of the walls.

The apodization thus modifies the profile of the walls, consisting in eliminating the sharp edges. More particularly, this modification consists in smoothing (or blunting) at least one edge of the wall, especially by rounding the latter until possibly obtaining a Gaussian profile of the walls. The smoothing of the edge therefore makes it possible to convert a sharp angle, close to 90°, of a wall into a curvilinear segment. This curvilinear segment may extend over a [symbol] the context of the invention, the apodization also includes the production of an array of walls as described above, in which each of the two flanks of said walls have an identical or different slope parallel to the surface of the substrate.

By definition, each wall has four edges, two at its top and two at its base. The term “base” of the wall is understood within the context of the invention to mean that side of the wall parallel to the surface of the substrate lying the shortest distance from said substrate. The term “top” of the wall is understood within the context of the invention to mean that side of the wall parallel to the surface of the substrate lying the furthest distance from said substrate, that is to say the opposite side from the substrate. The smoothing of the edges is carried out at the base and/or at the top of the walls. Advantageously, each wall has at least one smoothed edge at its top. Preferably, each wall has smoothed edges at its top. The smoothing of the wall edges may be symmetrical or asymmetrical. It is also possible within the context of the invention for the array of cells to comprise walls having different apodized profiles.

In a first embodiment, the smoothing of the edges may in particular be obtained by a chemical or physico-chemical etching process. Among etching processes that can be used in this application, mention may be made for example of plasma etching.

In a second embodiment of the invention, the apodized profile of the walls is obtained directly during production of said walls, by the use of a mask, which is placed at a variable and controlled distance from the material during the process of producing the walls. The use of such a mask is compatible with the processes for producing the walls and therefore with the [symbol] processes may be mentioned, by way of nonlimiting example, processes such as hot printing, hot embossing, micromolding, hard, soft, positive or negative photolithography, microdeposition, such as microcontact printing, screen printing or ink jet printing. Advantageously, to produce an apodized profile by using a mask, a process for producing the walls chosen from micromolding and photolithography is used.

It is also possible when producing the array of cells, and therefore the array of walls of apodized profile, to combine a process for producing said walls as described above with at least one etching process.

The geometry of the array of cells is characterized by dimensional parameters which may in general relate to the dimensions (d) of the cells parallel to the surface of the optical component, to their height corresponding to the height (h) of the walls that separate them, and to the thickness (e) of these walls (measured parallel to the surface of the component). Parallel to the surface of the optical component, the cells are preferably separated by walls with a thickness (e) of between 0.10 μm and 10 μm, preferably between 0.5 μm and 8 μm. Owing to the apodized profile of the walls, and therefore the smoothing of the edges of said walls, their thickness at the base is greater than their tangential thickness at their top. Advantageously, a wall of apodized profile has a tangential thickness at its top (S) of between 5% and 95% of the thickness at its base (B).

The walls have a height of between 1 μm and 50 μm, and preferably between 1 μm and 20 μm.

As described above, the walls with an apodized profile have their edges smoothed at their base and/or their top and optionally have flanks of identical or [symbol] between 90° and 15°, preferably between 90° and 45°, to a straight line parallel to the surface of the substrate.

The set of walls (and consequently the set of cells of the optical component) may be formed directly on a rigid transparent support, or within a flexible transparent film subsequently transferred onto a rigid transparent support. Said rigid transparent support may be convex or concave, or planar on the side receiving the set of cells.

Within the context of the invention, the set of juxtaposed cells is preferably configured in such a way that the fill factor τ, defined as the area occupied by the cells filled with the substance per unit area of the component, is greater than 90%. In other words, the cells of the set occupy at least 90% of the area of the component, at least in a region of the component which is provided with the set of cells. Advantageously, the fill factor is between 90% and 99.5% inclusive.

The substance having an optical property contained in at least some of the cells is in liquid or gel form. Said substance may in particular have at least one of the optical properties chosen from coloration, photochromism, polarization and refractive index.

Another object of the present invention is a method of producing an optical component as defined above, which includes the formation on a substrate of an array of walls with apodized profile in order to define the cells parallel to said surface of the component, the collective or individual filling of the cells with the substance having an optical property in liquid or gel form, and the sealing of the cells on their opposite side from the substrate. [symbol] several groups of cells containing different substances. Likewise, each cell may be filled with a substance having one or more optical properties as defined above. It is also possible to stack several sets of cells over the thickness of the component. In this embodiment, the sets of cells may have identical or different properties within each layer, or the cells within each set of cells may also have different optical properties.

Another aspect of the invention relates to an optical component used in the above method. This optical component comprises at least one transparent set of cells juxtaposed parallel to one surface of the component, each cell being separated by walls with an apodized profile. Each cell is hermetically sealed and contains at least one substance having an optical property.

Yet another aspect of the invention relates to a transparent optical element, especially a spectacle lens, produced by cutting such an optical component. A spectacle lens comprises an ophthalmic lens. The term “ophthalmic lens” is understood to mean lenses that can be fitted into a spectacle frame in order to protect the eye and/or to correct the vision, these lenses being chosen from among afocal, unifocal, bifocal, trifocal and progressive lenses. Although ophthalmic optics is a preferred field of application of the invention, it will be understood that this invention is applicable to transparent optical elements of other types, such as for example lenses for optical instruments, filters, especially for photolithography, optical viewing lenses, ocular visors, optics for illumination devices, etc. Within the invention, included in ophthalmic optics are ophthalmic lenses, but also contact lenses and ocular implants.

[symbol] will become apparent in the description below of nonlimiting exemplary embodiments, with reference to the appended drawings, in which:

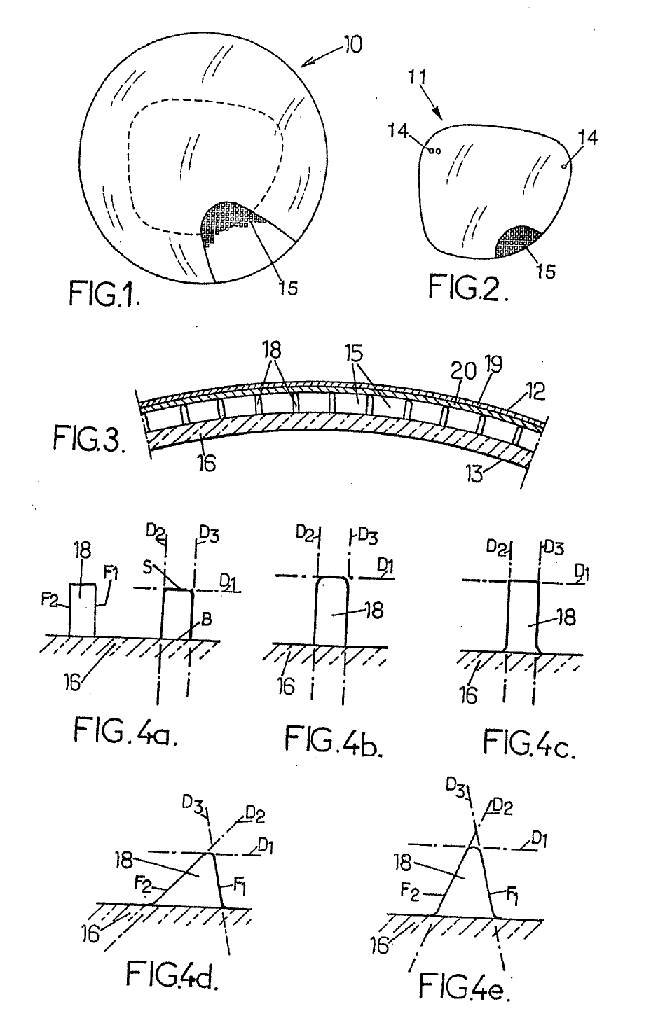

FIG. 1 is a front view of an optical component according to the invention;

FIG. 2 is a front view of an optical element obtained from this optical component;

FIG. 3 is a schematic sectional view of an optical component according to one embodiment of the invention; and

FIGS. 4a to 4e show a front view of different wall profiles, FIG. 4a showing a wall with an unapodized profile and FIGS. 4b to 4e showing a wall with an apodized profile.

The optical component 10 shown in FIG. 1 is a blank for a spectacle lens. A spectacle lens comprises an ophthalmic lens as defined above. Of course, although ophthalmic optics is a preferred field of application of the invention, it will be understood that this invention is applicable to transparent optical elements of other types.

FIG. 2 shows a spectacle lens 11 obtained by cutting the blank 10 along a predefined outline, shown by the dotted line in FIG. 1. This outline is a priori arbitrary, provided that it is inscribed within the area of the blank. Mass-produced blanks can thus be used to obtain lenses which can be fitted into a large variety of spectacle frames. The edge of the cut lens may be trimmed without any problem, in a conventional manner, in order to give it a shape matched to the spectacle frame and to the method of fastening the lens to this spectacle frame and/or for esthetic reasons. It is also possible to drill holes 14 into it, for example for receiving screws used to fasten it to the spectacle frame. [symbol] industry standards, for example with a circular outline of 70 mm (millimeters), a convex front face 12 and a concave rear face 13 (FIG. 3). The conventional cutting, trimming and drilling tools may thus be used to obtain the lens 11 from the blank 10.

In FIGS. 1 and 2, the surface layers have been partially cut away so as to reveal the pixelated structure of the blank 10 and of the lens 11. This structure consists of an array of cells or microcavities 15 formed in a layer 17 of the component, each cell being separated by walls of apodized profile 18 (FIG. 3). In these figures, the dimensions of the layer 17, of the walls 18 and of the cells 15 have been exaggerated relative to those of the blank 10 and its substrate 16, so as to make it easier to examine the drawing.

The layer 17 incorporating the array of cells 15 may be covered with a number of additional layers 19, 20 (FIG. 1), as is usual in ophthalmic optics. These layers have for example an impact resistance function, scratch resistance function, coloration function, antireflection function, antisoiling function, etc. In the example shown, the layer 17 incorporating the array of cells is placed immediately above the transparent substrate 16, but it will be understood that one or more intermediate layers may lie between them, such as layers having impact resistance, scratch resistance or coloration functions.

Moreover, it is possible for several arrays of cells to be present in the multilayer stack formed on the substrate. Thus, it is possible for example for the multilayer stack to comprise in particular one layer comprising arrays of cells containing a substance for giving the element photochromic functions and another layer for giving the element refractive index variation [symbol] also be alternated with additional layers. This is because the layer incorporating the array of cells may be covered by a number of additional layers, as is usual in ophthalmic optics. These layers have for example an impact resistance function, a scratch resistance function, a coloration function, an antireflection function, an antisoiling function, etc.

FIG. 4a shows a wall 18 of unapodized profile described here as reference. This wall has a base (B) and a top (S) as defined above. The top and the base each have two edges with sharp angles close to 90°. The straight line (Dl) symbolizes the tangent to the top of said wall. The straight lines D2 and D3 symbolize the straight lines tangential to each flank of a wall. In the case of a wall with an unapodized profile, each of the flanks (F1, F2) of said wall is perpendicular to the straight line D1, which is parallel to the substrate 16 or to the film serving as support for the walls, which may subsequently be transferred onto a substrate 16.

FIG. 4b shows a first variant of a wall with an apodized profile. In this situation, the apodization is formed by smoothing the two edges present on the top (S) of the wall 18. The thickness of the wall measured at the tangent (D1) of the top (S) of the wall represents about 90% of the thickness of the wall at its base (B).

FIG. 4c shows a second variant of a wall with an apodized profile. In this situation, the apodization is formed by smoothing the two edges present at the base (B) of the wall 18.

FIG. 4d shows a fourth variant of a wall with an apodized profile, in which the two edges present at the top and one edge (A1) present at the base are smoothed. [symbol] different slope, the flank (F1) having a slope at 45° and a flank (F2) having a slope at 75° to the surface of the substrate 16. The thickness of the wall measured at the tangent (D1) of the top (S) of the wall represents less than 10% of the thickness of the wall at its base (B).

FIG. 4e shows a third variant of a wall with an apodized profile. In this situation, the apodization is formed by smoothing the edges at the top (S) and at the base (B) of the wall 18, the smoothing being symmetrical and resulting in an apodized wall of Gaussian profile.

The transparent substrate 16 may be made of glass of various polymer materials commonly used in ophthalmic optics. By way of nonlimiting indication, the polymer materials that can be used include: polycarbonate materials; polyamides; polyimides; polysulfones; polyethylene terephthalate/polycarbonate copolymers; polyolefins, especially polynorbornene; diethylene glycol bis(allyl carbonate) polymers and copolymers; (meth)acrylic polymers and copolymers, especially (meth)acrylic polymers and copolymers derived from bisphenol A; thio(meth)acrylic polymers and copolymers; urethane and thiourethane polymers and copolymers; epoxy polymers and copolymers; and episulfide polymers and copolymers.

The layer 17 incorporating the array of cells is preferably located on its convex front face 12, the concave rear face 13 remaining free so as to be optionally formed by machining and polishing, if necessary. The optical component may also be located on the concave face of a lens. Of course, the optical component may also be incorporated into a flat optical element.

The cells are filled with the substance having an optical property, in the liquid or gel state. A prior treatment of the front face of the component may optionally be applied so as to facilitate surface wetting of the material of the walls and of the bottom of the microcavities. The solution or suspension forming the substance having an optical property may be the same for all the microcavities of the array, in which case it may simply be introduced by immersing the component in an appropriate bath, by a process of the screen-printing type, by a spin coating process, by a process for spreading the substance using a roller or a doctor blade, or else by a spray process. It is also possible for the individual microcavities to be locally injected using an ink jet head.

To hermetically seal an array of filled microcavities, an adhesive-coated plastic film is for example applied, this being thermally welded or hot-laminated onto the top of the walls 18. It is also possible to deposit onto the region to be closed off a curable material in solution, this material being immiscible with the substance having an optical property contained in the microcavities, and then to cure this material, for example using heat or irradiation.

Once the array of microcavities 15 has been completed, the component may receive the additional layers or coatings 19, 20 in order to complete its manufacture. Components of this type are mass produced and then stored, to be taken up again later and individually cut according to the requirements of a customer.

If the substance having an optical property is not intended to remain in the liquid or gel state, a solidification treatment may be applied to it, for example a heating and/or irradiation sequence, at an appropriate stage after the moment when the substance has been deposited.

In a variant, the optical component consisting of an array of microcavities is constructed in the form of a flexible transparent film. Such a film can be produced by techniques similar to those described above. In this case, the film can be produced on a plane substrate, i.e. one that is not convex or concave.

The film is for example manufactured on an industrial scale, with a relatively large size, and then it is cut to the appropriate dimensions in order to be transferred onto the substrate 16 of a blank. This transfer may be carried out by adhesively bonding the flexible film, by thermoforming the film, or even by a physical adhesion effect in a vacuum. The film may then receive various coatings, as in the previous case, or may be transferred onto the substrate 16 which is itself coated with one or more additional layers as described above.

In one field of application of the invention, the optical property of the substance introduced into the microcavities 15 is its refractive index. The refractive index of the substance is varied over the surface of the component in order to obtain a corrective lens. In a first embodiment of the invention, the variation may be produced by introducing substances of different indices during the manufacture of the array of microcavities 15.

In another embodiment of the invention, the variation may be achieved by introducing into the microcavities 15 a substance whose refractive index may be subsequently adjusted by irradiation. The writing of the corrective optical function is then carried out by exposing the blank 10 or the lens 11 to light whose energy varies over the surface in order to obtain the desired index profile, so as to correct the vision of a patient. This light is typically that produced by a laser. the writing equipment being similar to that used for etching CD-ROMs or other optical memory media. The greater or lesser exposure of the photosensitive substance may result from a variation in the power of the laser and/or from the choice of the exposure time.

Among the substances that can be used in this application, mention may be made, for example, of mesoporous materials and liquid crystals. The liquid crystals may be frozen by a polymerization or curing reaction, for example one induced by irradiation. Thus, they may be frozen in a chosen state in order to introduce a predetermined optical retardation in the lightwaves that pass through them. In the case of a mesoporous material, the refractive index of the material is controlled through the variation in its porosity. Another possibility is to use photopolymers that have a well-known property of changing their refractive index over the course of the irradiation-induced curing reaction. These index changes are due to a modification of the density of the material and to a change in the chemical structure. It will be preferable to use photopolymers that undergo only a very small volume change during the curing reaction.

The selective curing of the solution or suspension is carried out in the presence of radiation that is spatially differentiated with respect to the surface of the component, so as to obtain the desired index variation. This variation is determined beforehand according to the estimated ametropia of a patient's eye to be corrected.

In another application of the invention, the substance introduced in liquid or gel form into the microcavities has a polarization property. Among the substances used in this application, mention may in particular be made of liquid crystals.

In another application of the invention, the substance introduced in liquid or gel form into the microcavities has a photochromic property. Among the substances used in this application, mention may be made, by way of examples, of photochromic compounds containing a central unit such as a spirooxazine, spiro-indoline-[2,3′]benzoxazine, chromene, spiroxazine homoazaadaman-tane, spirofluorene-(2H)-benzopyrane or naphtho[2,1-b]-pyrane core.

Within the context of the invention, the substance having an optical property may be a dye, or a pigment capable of modifying the degree of transmission.

1. A method of producing a transparent optical element, which includes the step of producing a transparent optical component having at least one set of cells juxtaposed parallel to one surface of the component, each cell being hermetically sealed and containing a substance having an optical property, the cells being separated by walls having an apodized profile.

2. The method as claimed in claim 1, in which the apodized profile of the wall is obtained during a step of smoothing at least one edge of said wall.

3. The method as claimed in claim 1, in which the apodized profile of the wall is obtained during a smoothing step carried out at the base and/or at the top of said wall.

4. The method as claimed in claim 1, in which the smoothing step is carried out on at least one edge of the top of the wall.

5. The method as claimed in claim 1, in which the smoothing step is carried out on both edges of the top of the wall.

6. The method as claimed in claim 1, in which the apodized profile of the wall additionally includes the production of said wall in which each of its two flanks have an identical slope parallel to the surface of the substrate.

7. The method as claimed in claim 1, in which the apodized profile of the wall additionally includes the production of said wall in which each of its two flanks have a different slope parallel to the surface of the substrate.

8. The method as claimed in claim 1, in which the smoothing of the wall edges is symmetrical or asymmetrical.

9. The method as claimed in claim 1, in which the smoothing of the edges provides the wall with a Gaussian profile.

10. The method as claimed in claim 1, in which the smoothing of the edge is carried out by a chemical or physico-chemical etching process.

11. The method as claimed in claim 10, in which the process is plasma etching.

12. The method as claimed in claim 1, in which the apodized profile of the wall is obtained directly during production of said wall, by using a mask during said method of production, which is placed at a variable and controlled distance from the material constituting said wall.

13. The method as claimed in claim 12, in which the process for producing said wall is chosen from hot printing, hot embossing, micromolding, photolithography, microdeposition, screen printing and ink jet printing.

14. The method as claimed in claim 13, in which the production process is chosen from micromolding and photolithography.

15. Method according to claim 1, in which the apodized profile of the wall is obtained by combining an etching process with a wall production process in the presence of a mask.

16. Method according to claim 1 which additionally includes a step of cutting the optical component along a defined contour on said surface, corresponding to a defined shape for the optical element.

17. The method as claimed in claim 1, which furthermore includes a step of drilling through the optical component in order to fasten the optical element to a retention support.

18. The method as claimed in claim 1, in which the set of cells of the optical component is formed directly on a rigid transparent support, or within a flexible transparent film subsequently transferred onto a rigid transparent support.

19. The method as claimed in claim 18, in which the rigid transparent support is chosen to be convex, concave, or planar on that side receiving the set of cells.

20. The method as claimed in claim 1, which includes the formation on a substrate of an array of walls with apodized profile in order to define the cells parallel to said surface of the component, the collective or individual filling of the cells with the substance having an optical property in liquid or gel form, and the sealing of the cells on their opposite side from the substrate.

21. An optical component comprises at least one transparent set of cells juxtaposed parallel to one surface of the component, each cell being separated by walls with an apodized profile, each cell being hermetically sealed and containing at least one substance having an optical property.

22. The optical component as claimed in claim 21, in which the substance having an optical property contained in at least some of the cells is in liquid or gel form.

23. The optical component as claimed in claim 21, in which the optical property is chosen from a coloration property, a photochromism property, a polarization property and a refractive index property.

24. The optical component as claimed in claim 21 in which the cells, parallel to the surface of the optical component, are separated by walls having a thickness (e) of between 0.10 μm and 10 μm.

25. The optical component as claimed in claim 24 in which the thickness of the walls is between 0.5 μm and 8 μm.

26. The optical component as claimed in claim 24 in which the thickness at the base of the wall is greater than the tangential thickness of the top of said wall.

27. The optical component as claimed in claim 26 in which wall at the tangential thickness of the wall at its top (S) is between 5% and 95% of the thickness of the base (B) of said wall.

28. The optical component as claimed in claim 21 in which the walls have a height of between 1 μm and 50 μm, and preferably between 1 μm and 20 μm.

29. The optical component as claimed in claim 21 in which the two flanks of a wall are identical or different.

30. The optical component as claimed in claim 21 in which the slope of the flank of one wall is between 90° and 15° to a straight line parallel to the surface of the substrate.

31. The optical component as claimed in claim 30 in which the slope of the flank of one wall is between 90° and 45° to a straight line parallel to the surface of the substrate.

32. The optical component as claimed in claim 21 in which the fill factor is between 90% and 99.5%.

33. The optical component as claimed in claim 21 in which the walls with apodized profile have at least one smoothed edge.

34. The optical component as claimed in claim 21 in which the walls with apodized at their base and/or their top.

35. The optical component as claimed in claim 21 in which the walls are apodized on at least one edge of the top of the wall.

36. The optical component as claimed in claim 21 in which the walls are apodized on both edges of the top of the wall symmetrically or asymmetrically.

37. The optical component as claimed in claim 21 in which the walls have two flanks of identical slopes parallel to the surface of the substrate.

38. The optical component as claimed in claim 21 in which the walls have two flanks with identical slopes parallel to the surface of the substrate.

39. Use of an optical component as claimed in claim 21 in the manufacture of a transparent optical element chosen from ophthalmic lenses, contact lenses, ocular implants, lenses for optical instruments, filters, optical sighting lenses, ocular visors, optics for illumination devices.

40. A spectacle lens produced by cutting an optical component as claimed in claim 21.

41. The spectacle lens as claimed in claim 40, in which at least one hole is drilled through the component in order to fasten the lens to a spectacle frame.
